(19) United States
(12) Patent Application Publication
(10) Pub. No.: US 2018/0131126 A1
(43) Pub. Date: May 10, 2018

(54) CABLE CONNECTOR

(71) Applicant: Molex, LLC, Lisle, IL (US)

(72) Inventors: Hai-Yan WANG, Dongguan (CN); Ling-Feng RAO, Dongguan (CN)

(73) Assignee: Molex, LLC, Lisle, IL (US)

(21) Appl. No.: 15/629,322

(22) Filed: Jun. 21, 2017

(30) Foreign Application Priority Data
Jul. 5, 2016 (CN) 201620704270.5

(51) Int. Cl. H01R 13/58; H01R 24/60

(52) U.S. Cl. CPC H01R 13/5845; H01R 2107/00; H01R 24/60

(57) ABSTRACT

A cable connector comprises: an insulative housing, a front portion of the insulative housing is provided with a mating cavity, and a rear portion of the insulative housing is provided with a receiving cavity, a middle portion of the insulative housing is vertically provided with a spacing wall to separate the mating cavity from the receiving cavity in a front-rear direction, the rear portion of the insulative housing is provided with four fixing holes communicating with the receiving cavity; two circuit boards arranged and spaced apart in an up-down direction, each circuit board comprises a mating portion protruding forwardly into the mating cavity and a wire connection portion positioned in the receiving cavity; a plurality of wires electrically connected to the wire connection portions of the circuit boards; an outer molding formed in the receiving cavity by injection molding and correspondingly formed with four fixing protrusions engaging with the four fixing hole; the outer molding covers the wires therein and fixes the wires in the insulative housing, rear ends of the wires extend out of the outer molding. The tension relief structure of the present disclosure has fewer components and is simpler in the manufacturing process.

### RELATED APPLICATIONS

This application claims priority to Chinese Application No. 201620704270.5, filed Jul. 5, 2016, which is incorporated herein by reference in its entirety.

### TECHNICAL FIELD

The present disclosure relates to a cable connector and more particularly to a cable connector structure which is firmly engaged and is easy to manufacture.

### BACKGROUND ART

Taiwanese patent TWM487548U discloses a mini serial attached SCSI (small computer system interface) high density connector used to engage with circuit boards and cables, which comprises: a front housing formed in a frame shape and having an insertion space in an axial direction; a rear housing combined by a first rear housing and a second rear housing; a positioning mechanism positioned between the first rear housing and the second rear housing, and used to provide a positioning function when the first rear housing and the second rear housing are combined; a first engaging mechanism positioned between the front housing and the rear housing and used to provide an engaging function when the front housing and the rear housing are combined; and the housing which is combined by the first rear housing and the second rear housing is inserted into the insertion space of the front housing. Such a cable connector structure improves the cable tension relief performance by combining and fixing the rear housing and the front housing together, and the rear housing is combined by the two rear housings, which requires more components and more complex manufacturing process.

### SUMMARY

A technical problem to be solved by the present disclosure is to overcome the above deficiencies existing in the prior art, and provide a cable connector which has a tension relief structure having fewer components and being simpler in the manufacturing process.

In view of the above technical problem, the present disclosure provides a cable connector which comprises: an insulative housing, a front portion of the insulative housing is provided with a mating cavity, and a rear portion of the insulative housing is provided with a receiving cavity, a middle portion of the insulative housing is vertically provided with a spacing wall to separate the mating cavity from the receiving cavity in a front-rear direction, the rear portion of the insulative housing is provided with at least one fixing hole communicating with the receiving cavity; two circuit boards arranged and spaced apart in an up-down direction, each circuit board comprises a mating portion protruding forwardly into the mating cavity and a wire connection portion positioned in the receiving cavity; a plurality of wires electrically connected to the wire connection portions of the circuit boards; an outer molding formed in the receiving cavity by injection molding and correspondingly formed with at least one fixing protrusion engaging with the at least one fixing hole; the outer molding covers the wires therein and fixes the wires in the insulative housing, rear ends of the wires extend out of the outer molding.

In some embodiments, the cable connector further comprises two inner moldings respectively covering connected positions between the two circuit boards and the wires therein, the two inner moldings cooperate with each other to seal a front portion of the receiving cavity.

In some embodiments, the outer molding is formed on a rear portion of the receiving cavity of the insulative housing by injection molding after a combination of the two circuit board, the plurality of wires and the two inner moldings is mounted into the insulative housing.

In some embodiments, an outer periphery of each inner molding is provided with a channel, the outer molding is correspondingly formed with protruding bars engaging with the channels.

In some embodiments, the two inner moldings are stacked together up and down, and the two inner moldings are provided with at least one positioning protrusion and at least one positioning recess which engage with each other on engage surfaces of the two inner moldings.

In some embodiments, the spacing wall is provided with two insertion openings, the mating portions of the two circuit boards respectively pass through the two insertion openings forwardly and protrude into the mating cavity, a width of the wire connection portion of each circuit board is larger than a width of the mating portion of each circuit board.

In some embodiments, the rear portion of the insulative housing is provided with two opposite side walls and a top wall connected to two top ends of the two side walls, the receiving cavity is enclosed by the two side walls and the top wall, the fixing hole is provided on the two side walls.

In some embodiments, an inner side of each of the two side walls of the insulative housing is recessed with two positioning grooves spaced apart in the up-down direction, two side edges of a rear portion of each circuit board are inserted into the corresponding positioning grooves.

In some embodiments, the outer molding is formed by injection molding a hot-melt plastic.

Compared with the prior art, the present disclosure forms a tension relief structure by forming the fixing protrusion on the outer molding which corresponds to the fixing hole of the insulative housing so as to firmly engage the two circuit boards and the wires with the insulative housing, the tension relief structure has fewer components and is simpler in the manufacturing process.

### BRIEF DESCRIPTION OF THE DRAWINGS

FIG. 1 is a perspective view of a preferred embodiment of a cable connector of the present disclosure.

FIG. 2 is a front view of the cable connector shown in FIG. 1.

FIG. 3 is a cross-sectional view taken along a line A-A of FIG. 2.

FIG. 4 is an exploded perspective view of the cable connector shown in FIG. 1.

FIG. 5 is a further exploded perspective view of the cable connector shown in FIG. 4.

FIG. 6 is a further exploded perspective view of the cable connector shown in FIG. 5.

FIG. 7 is a further exploded perspective view of the cable connector shown in FIG. 6.

FIG. 8 is a perspective view of another preferred embodiment of the cable connector of the present disclosure.

FIG. 9 is a front view of the cable connector shown in FIG. 8.

FIG. 10 is a cross-sectional view taken along a line A-A of FIG. 9.

FIG. 11 is an exploded perspective view of the cable connector shown in FIG. 8.

FIG. 12 is a further exploded perspective view of the cable connector shown in FIG. 11.

FIG. 13 is a further exploded perspective view of the cable connector shown in FIG. 12.

### DETAILED DESCRIPTION OF PREFERRED EMBODIMENTS

While the present disclosure may be susceptible to embodiment in different forms, there is shown in the Figures, and will be described herein in detail, specific embodiments, with the understanding that the present disclosure is to be considered an exemplification of the principles of the present disclosure, and is not intended to limit the present disclosure to that as illustrated.

As such, references to a feature are intended to describe a feature of an example of the present disclosure, not to imply that every embodiment thereof must have the described feature. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the present disclosure, are not absolute, but relative. These representations are appropriate when the elements are in the position shown in the Figures. If the description of the position of the elements changes, however, these representations are to be changed accordingly.

Hereinafter two preferred embodiments of the present disclosure will be further described in detail in combination with the accompanying figures.

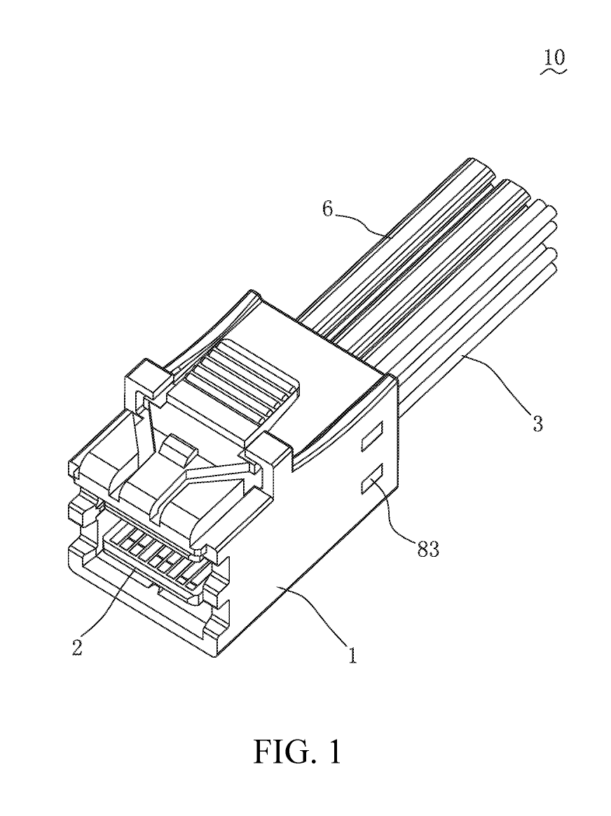

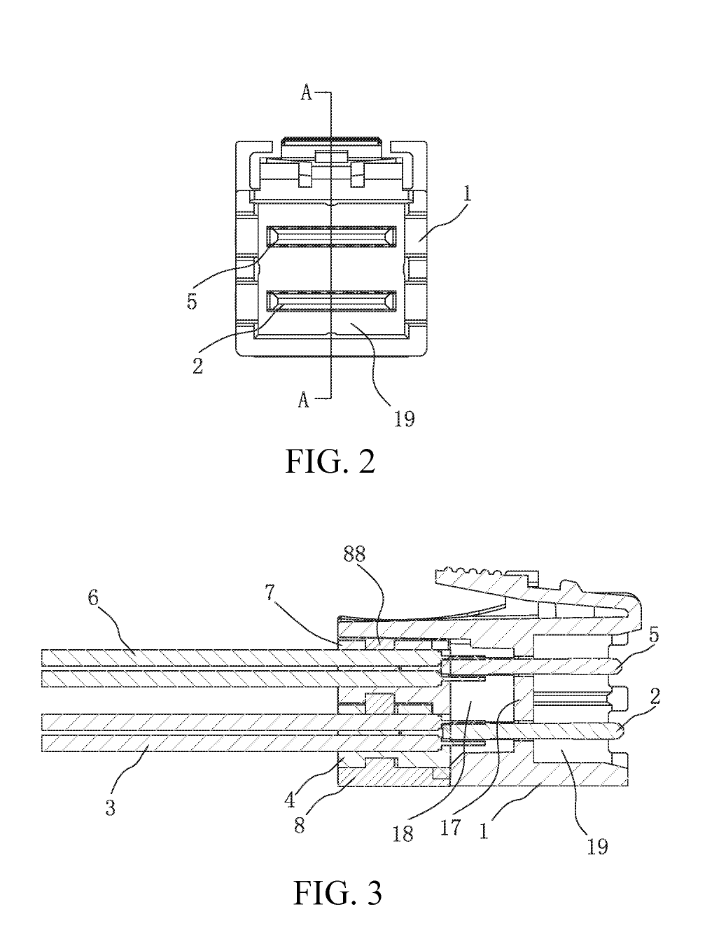

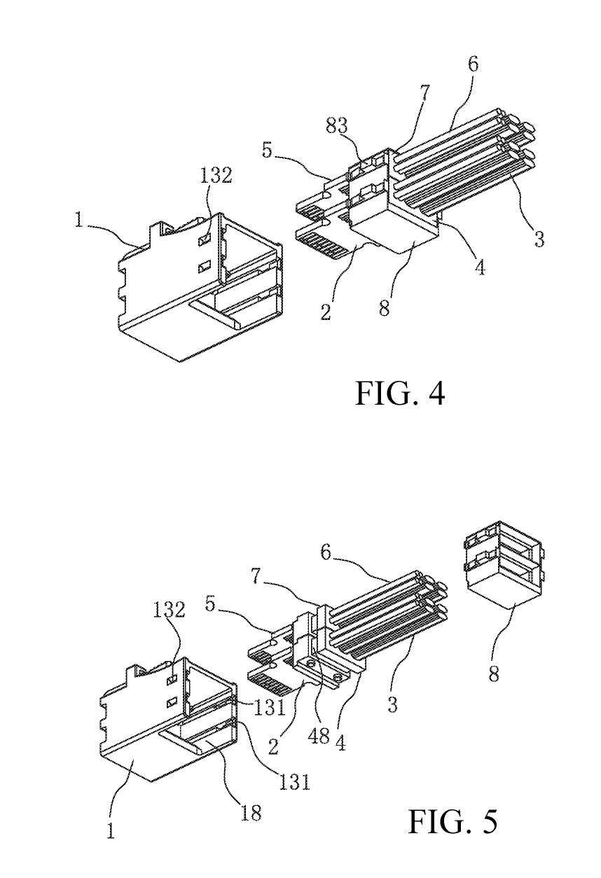

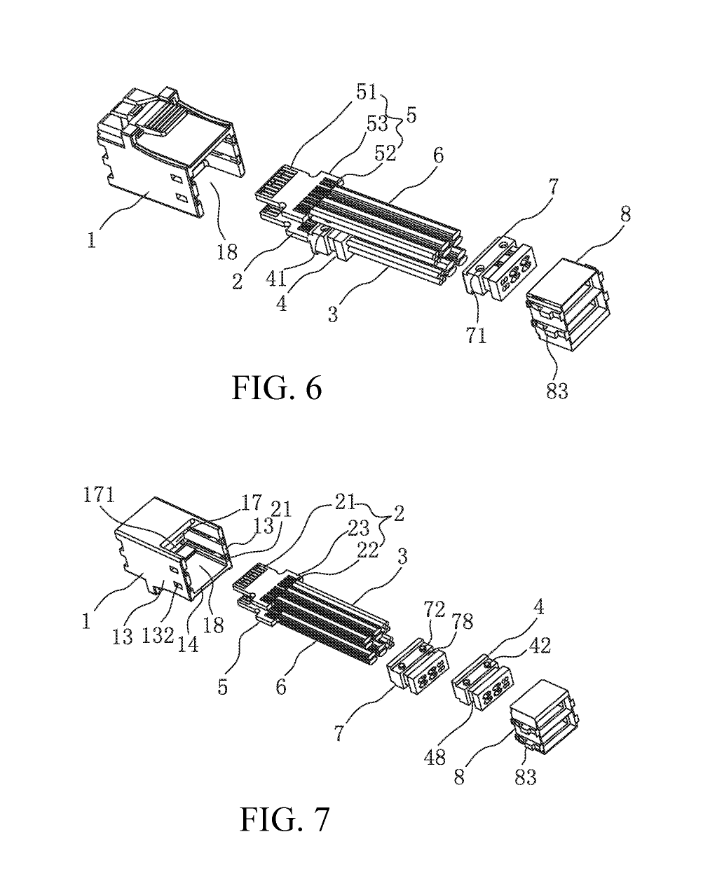

Referring to FIG. 1 to FIG. 7, the present disclosure takes a Mini-SAS cable connector as an example and provides a preferred embodiment, the cable connector 10 comprises: an insulative housing 1; two circuit boards 2, 5 arranged and spaced apart in an up-down direction; a plurality of wires 3, 6; two inner moldings 4, 7 respectively covering a connected position between the circuit board 2 and the wires 3 and a connected position between the circuit board 5 and the wires 6; and an outer molding 8 further covering outer peripheries of the inner moldings 4, 7. The cable connector 10 is a straight line design, that is, the wires 3, 6 extend along a front-rear direction which is the same as an insertion direction of the cable connector 10.

The insulative housing 1 is integrally formed by injection molding. A front portion of the insulative housing 1 is provided with a mating cavity 19, and a rear portion of the insulative housing 1 is provided with a receiving cavity 18. The rear portion of the insulative housing 1 is provided with four fixing holes 132 communicating with the receiving cavity 18. A middle portion of the insulative housing 1 is vertically provided with a spacing wall 17 to separate the mating cavity 19 from the receiving cavity 18 in the front-rear direction. The spacing wall 17 is provided with two insertion openings 171, and the two circuit boards 2, 5 respectively pass through the two insertion openings 171 forwardly and protrude into the mating cavity 19 to achieve mating with another mating connector (not shown in figure). Specifically, the rear portion of the insulative housing 1 is provided with two opposite side walls 13 and a top wall 14 connected to two top ends of the two side walls 13, and the receiving cavity 18 is enclosed by the two side walls 13 and the top wall 14. Each side wall 13 is provided with the two fixing holes 132. An inner side surface of each side wall 13 is recessed with two positioning grooves 131 spaced apart in the up-down direction for respectively engaging with two edges of the circuit boards 2, 5.

Each circuit board 2, 5 comprises a mating portion 21, 51 protruding into the mating cavity 19 and a wire connection portion 22, 52 positioned in the receiving cavity 18. A width of the wire connection portion 22, 52 is greater than a width of the mating portion 21, 51 so as to function as limiting the circuit board 2, 5 to further move forwardly. two sides of a rear portion of each circuit board 2, 5 are provided with positioning flanges 23, 53 which are correspondingly inserted into the corresponding positioning grooves 131. This structure is beneficial for the circuit boards 2, 5 to engage with the insulative housing 1 and prevents the rear portions of the circuit boards 2, 5 from vibration up and down.

Front ends of the wires 3, 6 are electrically connected to the wire connection portions 22, 52 of the corresponding circuit boards 2, 5. Rear ends of the wires 3, 6 extend backwardly out of the outer molding 8. Specifically, the front ends of the wires 3, 6 are correspondingly soldered on pads of the wire connection portions 22, 52 of the circuit boards 2, 5.

An outer periphery of each inner molding 4, 7 is provided with a channel 48, 78. The two inner moldings 4, 7 are stacked together up and down and each are formed with a horizontal engage surface. the two inner moldings 4, 7 are correspondingly provided with a positioning protrusion 72 and a positioning recess 41 which engage with each other at the engage surfaces of the two inner moldings 4, 7, so as to correspondingly position the two inner moldings 4, 7 together. Specifically, the two inner moldings 4, 7 are basically the same in shape and structure. The inner molding 4 covers the outer periphery of the connected position between the circuit board 2 and wires 3 so as to function as preventing electrical connection from being disconnected. A bottom side of the inner molding 4 is provided with two positioning protrusions 42, and the top side is provided with the two positioning recesses 41. The inner molding 7 covers the outer periphery of the connected position between the circuit board 5 and the wires 6. A bottom side of the inner molding 7 is provided with the two positioning protrusions 72, and a top side is provided with two positioning recesses 71. When the inner molding 4 and the inner molding 7 are stacked together, the positioning protrusions 72 of the bottom side of the inner molding 7 positioned above are correspondingly inserted into the positioning recesses 41 of the inner molding 4 positioned below. The two inner moldings 4, 7 which are stacked together are inserted into the insulative housing 1 from the rear to the front, which can seal the front portion of the receiving cavity 18, so that it facilitates the subsequent molding of the outer molding 8.

The outer molding 8 is formed on a rear portion of the receiving cavity 18 of the insulative housing 1 by injection molding after a combination of the two circuit board 2, 5, the wires 3, 6 and the two inner moldings 4, 7 is mounted into the insulative housing 1. The outer molding 8 are correspondingly formed with fixing protrusions 83 which engage with the fixing holes 132 of the insulative housing 1, the fixing protrusions 83 fully fill the fixing holes 132 respectively to obtain a stronger engaging force so that the two circuit boards 2, 5 and the wires 3, 6 firmly engage with the insulative housing 1, thereby preventing a pull force applied to wires 3, 6 by the outside from producing an disadvantageous influence on mechanical connection relationship or electrical connection relationship of the cable connector 10. The outer molding 8 is also correspondingly formed with protruding bars 88 which engage with the channels 48, 78 of the two inner moldings 4, 7. It is worth noting that, although this design has the two inner moldings 4, 7, in some unillustrated embodiments, the inner moldings 4, 7 may be omitted, it can also function as the tension relief purpose by directly forming the outer molding which covers the circuit boards 2, 5 and the wire 3, 6 and making the fixing protrusions 83 of the outer molding engage with the fixing holes 132.

A manufacturing process of the cable connector 10 of the embodiment is generally comprises: correspondingly soldering the front ends of the wires 3 to the pads of the wire connection portion 22 of the circuit board 2, allowing the inner molding 4 to cover the outer periphery of the connected position between the wires 3 and circuit board 2 by injection molding; similarly, correspondingly soldering the front ends of the wires 6 to the pads of the wire connection portion 52 of the circuit board 5, allowing the inner molding 7 to cover the outer periphery of the connected position between the wires 6 and circuit board 5 by injection molding; stacking the two inner moldings 4, 7 together up and down, and inserting the circuit board 2, 5 into the insulative housing 1 from the rear to the front respectively along the positioning grooves 131 until inserting the circuit board 2, 5 in place and the two inner moldings 4, 7 seal the front portion of the receiving cavity 18, and the mating portions 21, 51 of the circuit boards 2, 5 correspondingly protrude into the mating cavity 19; finally, forming an outer molding 8 which engages with the insulative housing 1 together on the two outer peripheries of the two inner moldings 4, 7 by injection molding.

Compared with the prior art, the present disclosure forms a tension relief structure by forming the fixing protrusions 83 on the outer molding 8 which correspond to the fixing holes 132 of the insulative housing 1 so as to firmly engage with the insulative housing 1, the tension relief structure has fewer components and is simpler in the manufacturing process.

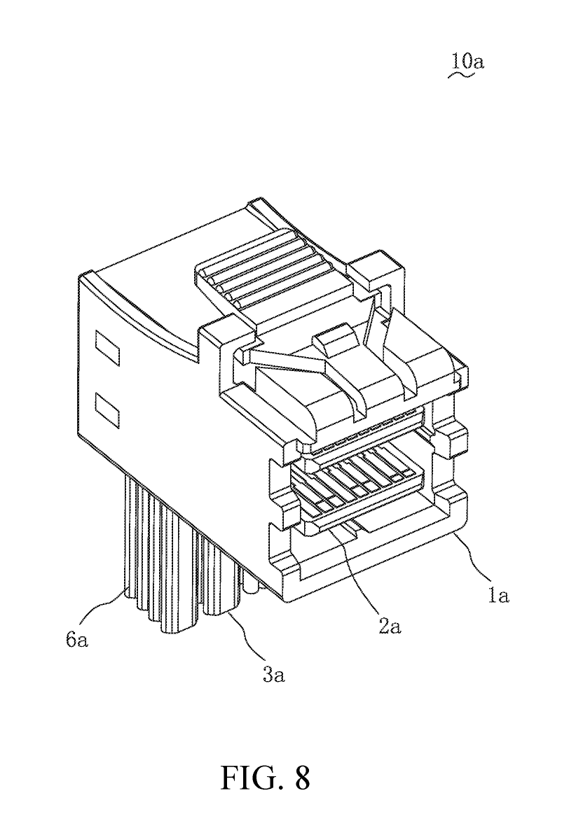

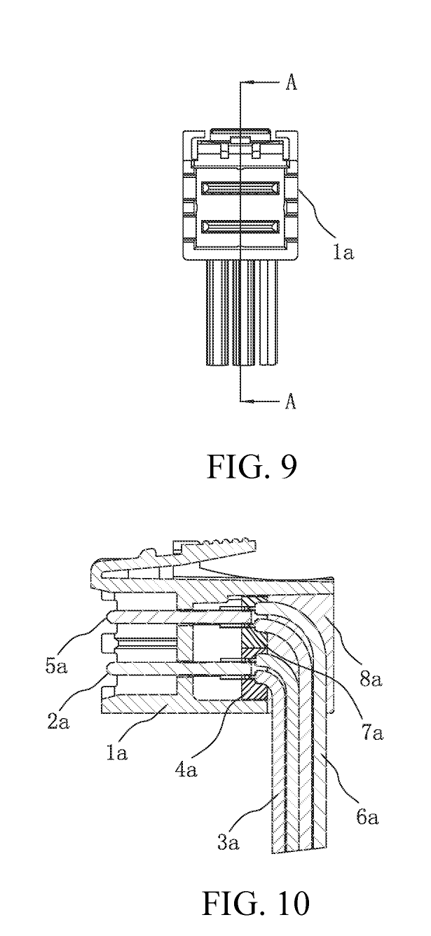

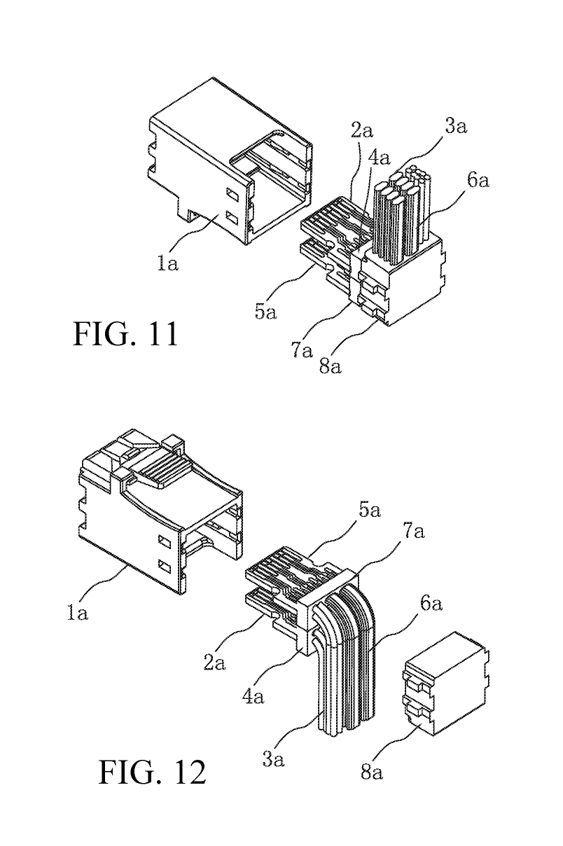

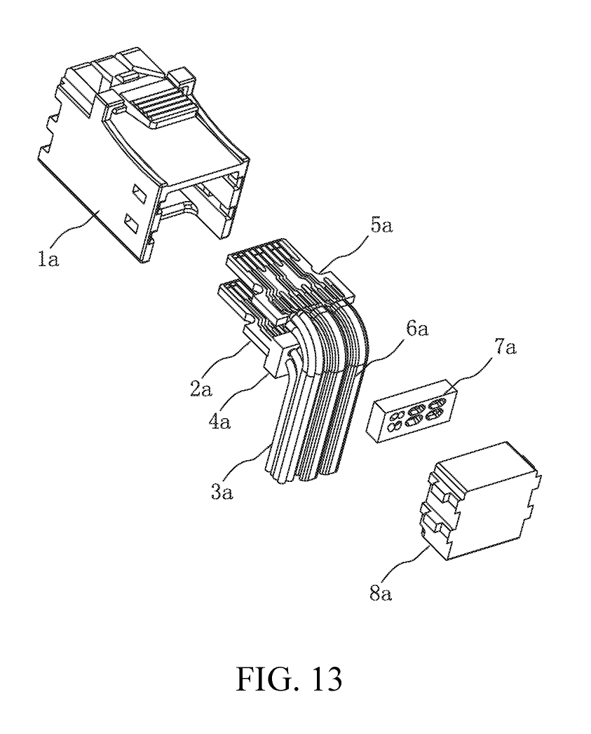

Referring to FIG. 8 to FIG. 13, the present disclosure takes a Mini-SAS cable connector as an example and provides another preferred embodiment, the cable connector 10a comprises: an insulative housing 1a; two circuit boards 2a, 5a mounted in the insulative housing 1a; a plurality of wires 3a, 6a connected to rear ends of the two circuit boards 2a, 5a; two inner moldings 4a, 7a respectively covering a connected position between the circuit boards 2a and the wires 3a and a connected position between the circuit board 5a and the wires 6a; and an outer molding 8a further covering outer peripheries of the two inner moldings 4a, 7a. The cable connector 10a is a right angle design, that is, a wire outlet direction of the wire 3a, 6a is substantially perpendicular to the insertion direction of the cable connector 10a. The shape and structure of the inner moldings 4a, 7a is different from the shape and structure of the aforementioned inner molding 4, 7: a length in the front-rear direction of the inner molding 4a, 7a is smaller than that of the aforementioned inner molding 4, 7; the inner molding 4a, 7a are not provided with the channel 48, 78 of the aforementioned inner molding 4, 7; the inner molding 4a, 7a also are not provided with the protrusions 42,72 and recesses 41,71 of the aforementioned inner molding 4, 7.

The above disclosure only relates to certain embodiments of the present disclosure, but does not limit implementing solutions of the present disclosure. According to the main concepts and spirit of the present disclosure, a person skilled in the art may make various variations or modifications. Therefore, the protection scope of the present disclosure is determined by the scope of the appended claims.

What is claimed is:

1. A cable connector comprising:
an insulative housing, a front portion of the insulative housing being provided with a mating cavity, and a rear portion of the insulative housing being provided with a receiving cavity, a middle portion of the insulative housing being vertically provided with a spacing wall to separate the mating cavity from the receiving cavity in a front-rear direction, the rear portion of the insulative housing being provided with at least one fixing hole communicating with the receiving cavity;
two circuit boards arranged and spaced apart in an up-down direction, each circuit board comprising a mating portion protruding forwardly into the mating cavity and a wire connection portion positioned in the receiving cavity;
a plurality of wires electrically connected to the wire connection portions of the circuit boards;
an outer molding formed in the receiving cavity by injection molding and correspondingly formed with at least one fixing protrusion engaging with the at least one fixing hole; the outer molding covering the wires therein and fixing the wires in the insulative housing, rear ends of the wires extending out of the outer molding.

2. The cable connector according to claim 1, wherein the cable connector further comprises two inner moldings respectively covering connected positions between the two circuit boards and the wires therein, the two inner moldings cooperate with each other to seal a front portion of the receiving cavity.

3. The cable connector according to claim 2, wherein the outer molding is formed on a rear portion of the receiving cavity of the insulative housing by injection molding after a combination of the two circuit board, the plurality of wires and the two inner moldings is mounted into the insulative housing.

4. The cable connector according to claim 3, wherein an outer periphery of each inner molding is provided with a channel, the outer molding is correspondingly formed with protruding bars engaging with the channels.

5. The cable connector according to claim 2, wherein the two inner moldings are stacked together up and down, and the two inner moldings are provided with at least one positioning protrusion and at least one positioning recess which engage with each other on engage surfaces of the two inner moldings.

6. The cable connector according to claim 1, wherein the spacing wall is provided with two insertion openings, the mating portions of the two circuit boards respectively pass through the two insertion openings forwardly and protrude into the mating cavity, wherein a width of the wire connection portion of each circuit board is larger than a width of the mating portion of each circuit board.

7. The cable connector according to claim 1, wherein the rear portion of the insulative housing is provided with two opposite side walls and a top wall connected to two top ends of the two side walls, the receiving cavity is enclosed by the two side walls and the top wall, the fixing hole is provided on the two side walls.

8. The cable connector according to claim 7, wherein an inner side of each of the two side walls of the insulative housing is recessed with two positioning grooves spaced apart in the up-down direction, two side edges of a rear portion of each circuit board are inserted into the corresponding positioning grooves.

9. The cable connector according to claim 1, wherein the outer molding is formed by injection molding a hot-melt plastic.
